(19) United States
(12) Patent Application Publication
(10) Pub. No.: US 2003/0159151 A1
(43) Pub. Date: Aug. 21, 2003

(54) Server, terminal device, system and method for controlling program recording

(76) Inventor: Kazuyuki Ikeda, Tokyo (JP)

Correspondence Address: FROMMER LAWRENCE & HAUG LLP, 745 FIFTH AVENUE, NEW YORK, NY, 10151, US

(21) Appl. No.: 10/314,040

(22) Filed: Dec. 6, 2002

(30) Foreign Application Priority Data
Dec. 7, 2001 (JP) 2001-374920

(51) Int. Cl. H04N 7/16; G06F 3/00; H04N 5/445; G06F 13/00; H04N 7/173

(52) U.S. Cl. 725/58; 725/1; 725/87; 725/39; 725/25; 725/61

(57) ABSTRACT

The present invention is intended to record a preselected program on a recording medium without fail. This is implemented by connecting a terminal device which controls the program recording operation of a program recorder for recording programs received by a receiving portion on a recording medium by a recording portion and a server with each other through a network, causing the server to generate a bill of fare containing the program start time information on programs to be broadcasted each time a program start time is updated, to, when the program start time of a program for which a program recording request was made by the terminal device, compare the program start time of the program for which the program recording request was made with the program start time of the program in the updated and latest bill of fare, to, if both the program start times are matched with each other, generate a program recording start command, and to transmit the generated program recording start command to the terminal device through the network, and in turn transmitting the command to the program recorder.

### BACKGROUND OF THE INVENTION

1. Field of the Invention

The present invention relates to a server, a terminal device, a system and a method for controlling program recording wherein programs to be recorded are preselected based on EPGs (Electronic Program Guides) and those programs are recorded on a recording medium.

2. Description of the Related Art

As the result of increase in channels due to digital broadcasting and the like, services wherein users select desired programs using EPGs (Electronic Program Guides) delivered from a server connected through a network and view the programs are provided.

The users can simply select desired programs through the GUI (Graphical User Interface) of the EPGs.

Further, the users can preselect programs to be recorded on a recorder or the like, referring to the EPGs delivered through the network, and thus these services are convenient.

However, the services have a problem. If a program broadcasting start time is delayed due to, for example, rebroadcasting of a baseball game, a special newscast, or the like, the user cannot cope with this after all the operations the user made for preselecting a program to be recorded according to a thus delivered EPG unless the user is in a place where the user can enter the changed recording start time of the program.

### SUMMARY OF THE INVENTION

The present invention aims at providing a server, a terminal device, a system and a method for controlling program recording wherein, even if the program start time of a program to be recorded on a recording medium preselected by the user is changed, the start time of program recording on the recording medium can be changed according to the changed program start time, and the preselected program can be recorded on the recording medium without fail.

In one aspect, the present invention resides in a server connected through a network with a terminal device which controls the program recording operation of a program recorder for recording a program received by a receiving means on a recording medium, the server having: a bill-of-fare generating means for generating a bill of fare containing program start time information indicating the program start time of programs to be broadcasted each time the program start time is updated; a bill-of-fare transmitting means for transmitting the bill of fare generated by the bill-of-fare generating means to the terminal device through the network; a program-recording-request receiving means for receiving a program recording request to record the specified program on the recording medium, the request being transmitted from the terminal device through the network based on the bill of fare transmitted to the terminal device by the bill-of-fare transmitting means; a comparing means for, when the program start time of the program for which the program recording request was made by the terminal device arrives, comparing the program start time of the program for which the program recording request was made with the program start time of the program in the latest bill of fare updated by the bill-of-fare generating means; a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means; and a program-recording-start command transmitting means for transmitting the program recording start command generated by the program-recording-start command generating means to the terminal device through the network.

As is clear from the above description, the server of the present invention allows users to record a desired program on a recording medium without fail even if the program start time is suddenly changed, by causing the bill-of-fare generating means to generate a bill of fare each time a program start time is updated, causing the comparing means to, when the program start time of a program for which a program recording request was made by a terminal device, compare the program start time of the program for which the program recording request was made with the program start time of the program in the updated and latest bill of fare, causing the program-recording-start command generating means to, if both the program start times are matched with each other, accordingly generate a program recording start command which is a control command to a program recorder for receiving and recording programs on the recording medium; and causing the program-recording-start command transmitting means to transmit the generated program recording start command.

In another aspect, the present invention resides in a terminal device which is connected with a server through a network and controls the program recording operation of a program recorder for recoding a program received by a receiving means on a recording medium, the terminal device having: a bill-of-fare receiving means for receiving a bill of fare which is transmitted from the server through the network and contains program start time information indicating the program start times of programs to be broadcasted; a program-recording-request transmitting means for transmitting a program recording request to record a specified program on the recording medium to the server through the network based on the bill of fare received by the bill-of-fare receiving means; and a program-recording-start command receiving means for receiving a program recording start command to start recording of the specified program on the recording medium, transmitted from the server.

As is clear from the above description, the terminal device of the present invention allows users to record a desired program on a recording medium without fail even if the program start time is suddenly changed, by causing a program-recording-start command receiving means to receive a program recording start command which is transmitted in response to a request to record a desired program made to the server by a program-recording-request transmitting means based on a bill of fare transmitted from the server and is a control command to a program recorder for starting recording of the specified program on the recording medium; and causing a command outputting means to transmit the received program recording start command to the program recorder.

In still another aspect, the present invention resides in a terminal device which is connected with the server through the network, having: a bill-of-fare receiving means for receiving bills of fare which is transmitted from the server through the network and contains program start time information indicating the program start times of programs to be broadcasted; a program-recording-request transmitting means for transmitting a program recording request to record a specified program on the recording medium to the server through the network based on the bill of fare received by the bill-of-fare receiving means; a program-recording-start command receiving means for receiving a program recording start command instructing to start recording of the program on the recording medium, transmitted from the server; a program receiving means for receiving the program listed in the bill of fare; a recording means for recording the program received by the program receiving means on the recording medium; and a controlling means for controlling the program receiving means and the recording means so that the program for which the program recording request was made is recorded on the recording medium according to the program recording start command received by the program-recording-start command receiving means.

As is clear from the above description, the terminal device of the present invention allows users to record a desired program on a recording medium without fail even if the program start time is suddenly changed, by causing the program-recording-start command receiving means to receive a program recording start command which is transmitted in response to a request to record a desired program made to the server by the program-recording-request transmitting means based on a bill of fare transmitted from the server and is a control command to the program recording means for starting recording of the specified program on the recording medium; and causing a controlling means to control a program receiving means for receiving programs and the program recording means according to the received program recording start command.

In yet another aspect, the present invention resides in a program recording control system wherein a terminal device which controls the program recording operation of a program recorder for recording programs received by a receiving means on a recording medium and a server are connected with each other through a network;

wherein the server has: a bill-of-fare generating means for generating a bill of fare containing program start time information indicating the program start times of programs to be broadcasted each time the program start time is updated, a bill-of-fare transmitting means for transmitting the bills of fare generated by the bill-of-fare generating means to the terminal device through the network, a program-recording-request receiving means for receiving a program recording request to record a specified program on the recording medium, transmitted from the terminal device through the network based on the bill of fare transmitted to the terminal device by the bill-of-fare transmitting means, a comparing means for, when the program start time of the program for which the program recording request was made by the terminal device arrives, comparing the program start time of the program for which the program recording request was made with the program start time of the program in the latest bill of fare updated by the bill-of-fare generating means, a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means, and a program-recording-start command transmitting means for transmitting the program recording start command generated by the program-recording-start command generating means to the terminal device through the network; and

wherein the terminal device comprises: a bill-of-fare receiving means for receiving bills of fare transmitted from the bill-of-fare transmitting means of the server through the network, a program-recording-request transmitting means for transmitting a program recording request to record a specified program on the recording medium to the server through the network based on the bill of fare received by the bill-of-fare receiving means, and a program-recording-start command receiving means for receiving the program recording start command transmitted from the program-recording-start command transmitting means of the server.

In further aspect, the present invention resides in a program recording control method for a program recording control system

wherein a terminal device which controls the program recording operation of a program recorder for recording programs received by a receiving means on a recording medium and a server are connected with each other through a network;

wherein the server generates a bill of fare containing program start time information indicating the program start times of programs to be broadcasted each time the program start time is updated, and transmits the generated bill of fare to the terminal device through the network;

wherein the terminal device receives the bill of fare transmitted from the server through the network, and transmits a program recording request to record a specified program on the recording medium to the server through the network based on the received bill of fare;

wherein the server receives the program recording request transmitted from the terminal device through the network, when the program start time of the program for which the program recording request was made by the terminal device arrives, compares the program start time of the program for which the program recording request was made with the program start time of the program in the updated and latest bill of fare, generates a program recording start command for starting recording of the specified program on the recording medium, according to the result of the comparison that the program start time of the program for which the program recording request was made is matched with the program start time of the program in the updated and latest bill of fare, and transmits the generated program recording start command to the terminal device through the network; and

wherein the terminal device receives the program recording start command transmitted from the server through the network.

As is clear from the above description, the system and the method for controlling program recording of the present invention allow users to record a desired program on a recording medium without fail even if the program start time is suddenly changed, by causing the server to generate a bill of fare each time a program start time is updated, to, when the program start time of a program for which a program recording request was made by a terminal device arrives, compare the program start time of the program for which the program recording request was made with the program start time of the program in the updated and latest bill of fare, to, if both the start times are matched with each other, accordingly generate a program recording start command which is a control command to a program recorder for receiving programs and recording the received programs on the recording medium, and to transmit the generated program recording start command to the terminal device; and causing the terminal device to receive the program recording start command which is transmitted in response to a request to record a desired program made to the server based on a bill of fare transmitted from the server and is a control command to the program recorder for starting recording of the specified program on the recording medium, and to transmit the received program recording start command to the program recorder.

In still further aspect, the present invention resides in a program recording control system wherein a server and a terminal device are connected with each other through a network,

wherein the server comprises: a bill-of-fare generating means for generating a bill of fare containing program start time information indicating the program start times of programs to be broadcasted each time the program start time is updated; a bill-of-fare transmitting means for transmitting bills of fare generated by the bill-of-fare generating means to the terminal device through the network; a program-recording-request receiving means for receiving a program recording request to record a specified program on a recording medium, transmitted from the terminal device through the network based on the bill of fare transmitted to the terminal device by the bill-of-fare transmitting means; a comparing means for, when the program start time of the program for which the program recording request was made by the terminal device arrives, comparing the program start time of the program for which the program recording request was made with the program start time of the program in the lasted bill of fare updated by the bill-of-fare generating means; a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means; and a program-recording-start command transmitting means for transmitting the program recording start command generated by the program-recording-start command generating means to the terminal device through the network; and

wherein the terminal device comprises: a bill-of-fare receiving means for receiving bills of fare transmitted from the bill-of-fare transmitting means of the server through the network; a program-recording-request transmitting means for transmitting a program recording request to record a specified program on the recording medium to the server through the network based on the bill of fare received by the bill-of-fare receiving means; a program-recording-start command receiving means for receiving the program recording start command transmitted from the program-recording-start command transmitting means of the server; a program receiving means for receiving programs listed in the bill of fare; a recording means for recording the programs received by the program receiving means on the recording medium; and a controlling means for controlling the program receiving means and the recording means so that the program for which the program recording request was made is recorded on the recording medium according to the program recording start command received by the program-recording-start command receiving means.

In yet further aspect, the present invention resides in a program recording control method for a program recording control system wherein a server and a terminal device are connected with each other through a network;

wherein the server generates a bill of fare containing program start time information indicating the program start times of programs to be broadcasted each time the program start time is updated, and transmits the generated bill of fare to the terminal device through the network;

wherein the terminal device receives the bill of fare transmitted from the server through the network, and transmits a program recording request to record a specified program on a recording medium to the server through the network based on the received bill of fare;

wherein the server receives the program recording request transmitted from the terminal device through the network; when the program start time of the program for which the program recording request was made by the terminal device arrives; compares the program start time of the program for which the program recording request was made with the program start time of the program in the latest bill of fare updated by the bill-of-fare generating means; generates a program recording start command for starting recording of the specified program on the recording medium, according to the result of the comparison that the program start time of the program for which the program recording request was made is matched with the program start time of the program in the latest bill of fare updated by the bill-of-fare generating means; and transmits the generated program recording start command to the terminal device through the network; and

wherein the terminal device receives the program recording start command transmitted from the server, and controls a program receiving means for receiving programs listed in the bill of fare and a recording means for recording the programs received by the program receiving means so that the program for which the program recording request was made is recorded on the recording medium according to the received program recording start command.

As is clear from the above description, the system and the method for controlling program recording of the present invention allow users to record a desired program on a recording medium without fail even if the program start time is suddenly changed, by causing the server to generate a bill of fare each time a program start time is updated, to, when the program start time of a program for which a program recording request was made by a terminal device arrives, compare the program start time of the program for which the program recording request was made with the program start time of the program in the updated and latest bill of fare, to, if both the start times are matched with each other, accordingly generate a program recording start command which is a control command to the program recorder for receiving programs and recording the received programs on the recording medium, and to transmit the generated program recording start command to the terminal device; and causing the terminal device to receive the program recording start command which is transmitted in response to a request to record a desired program made to the server based on a bill of fare transmitted from the server and is a control command to the program recording means for starting recording of the specified program on the recording medium, and to control the program receiving means for receiving programs and the program recording means according to the received program recording start command.

Other and further objects, features and advantages of the invention will appear more fully from the following description.

### BRIEF DESCRIPTION OF THE DRAWINGS

FIG. 1 is a drawing for explaining the configuration of a program recording control system, illustrated as a first embodiment of the present invention.

FIG. 2 is a schematic diagram of relevant parts for explaining the configuration of the terminal device in the same program recording control system.

FIG. 3 is a drawing for explaining the configuration of a program recording control system, illustrated as a second embodiment of the present invention.

FIG. 4 is a flowchart for explaining the operation of the program recording control system, illustrated as embodiments of the present invention, performed when a program to be recorded is preselected.

FIG. 5 is a flowchart for explaining the operation of the server in the same program recording control system, performed when a preselected program to be recorded is recorded on a recording medium.

FIG. 6 is a flowchart for explaining the operation of the terminal device in the same program recording control system, performed when a preselected program to be recorded is recorded on a recording medium.

### DETAILED DESCRIPTION OF THE PREFERRED EMBODIMENTS

Referring to the drawings, embodiments of the server, the terminal device, the system and the method for controlling program recording of the present invention will be described below.

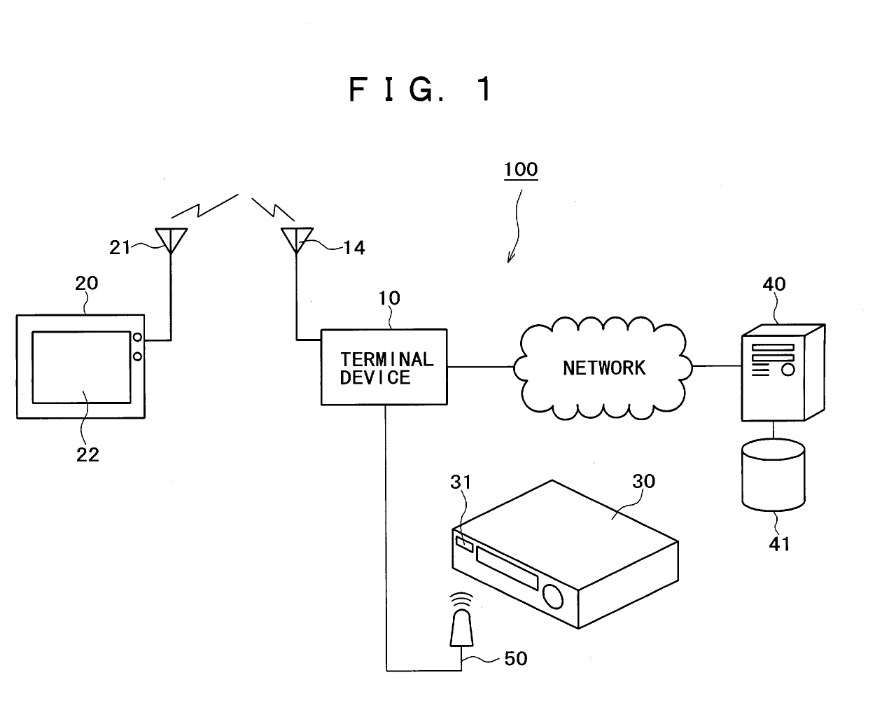

First, referring to FIG. 1, the configuration of a program recording control system 100 as the first embodiment to which the present invention is applied will be described.

The program recording control system 100 involves a terminal device 10, a monitor 20 for outputting and displaying information of the terminal device 10, a recorder 30 for recording programs on a recording medium, and a server 40. In the program recording control system 100, the terminal device 10 and the server 40 are connected with each other through a network, such as a public telephone network, and the recording operation of the recorder 30 and the like can be controlled under instructions from the server 40 through the terminal device 10.

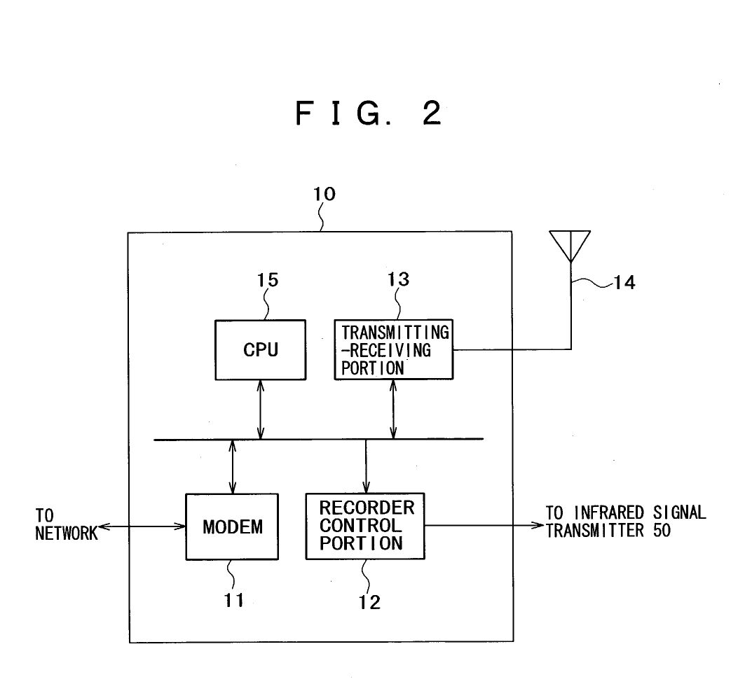

As shown in FIG. 2, the terminal device 10 has a modem 11, a recorder control portion 12, a transmitting-receiving portion 13, a radio antenna 14, and CPU 15.

The modem 11 modulates data transmitted and demodulates carrier waves received for data transfer to and from the server 4 through the network.

The recorder control portion 12 outputs control commands for controlling the operation of the recorder 30 and thereby controls the recorder 30. Control commands outputted from the recorder control portion 12 are control commands transmitted from the server 40 and control commands generated at the recorder control portion 12 itself based on information or the like transmitted from the server 40.

Control commands transmitted from the server 40 to the recorder control portion 12 are recording start commands, including power ON command for turning on the power to the recorder 30, received channel control command for specifying frequencies received by a tuner built in the recorder 30, recording start command for controlling the recording portion of the recorder 30 to record programs on a recording medium, and the like. As mentioned above, recording start command is a generic name for commands for controlling the recorder 30, generated at and transmitted from the server 40 when a program is recorded.

Control commands generated at the recorder control portion 12 include recording stop command for stopping the operation of recording on the recording medium at the recording portion of the recorder 30, which command is generated based on recording end time information, or information indicating the end time of a program to be broadcasted, power OFF command for turning off the power to the recorder 30, and the like.

A control command outputted from the recorder control portion 12 is inputted to an infrared signal transmitter 50, converted into an infrared signal there, and transmitted to the recorder 30.

Further, the recorder control portion 12 has a timer (not shown) for managing time when control commands are generated, and memory (not shown) for storing specified information transmitted together with control commands from the server 40.

The transmitting-receiving portion 13 has a frequency modulator for modulating by a specified modulation method data and commands transmitted for transmitting and receiving data and commands to and from the monitor 20 by radio, a demodulator for demodulating received carrier waves, and the like.

The radio antenna 14 is an antenna for transmitting and receiving data and commands to and from the monitor 20 by radio.

The CPU 15 controls each operation part of the terminal device 10 in a centralized manner.

Here, referring to FIG. 1 again, the configuration of the program recording control system 100 will be continuously described.

The monitor 20 has a radio antenna 21 for transmitting and receiving data and commands to and from the terminal device 10 by radio and a transmitting-receiving portion (not shown) provided with a frequency modulator-demodulator.

Further, the monitor 20 has a liquid crystal display portion 22 for displaying data, for example, EPGs (Electronic Program Guides), transmitted and received from the terminal device 10. The liquid crystal display portion 22 is constituted as touch panel, through which the user can enter specified commands and data.

Respectively provided with the antennas 14 and 21 for radio communication, a frequency modulator-demodulator, and the like, the terminal device 10 and the monitor 20 are capable of transmitting and receiving data and commands by radio. The monitor 20 is capable of accepting entries of various commands for controlling the terminal device 10, and the terminal device 10 can be remotely controlled from a place at a specified distance by so designing the monitor 20 that the shape and weight thereof will make the monitor convenient to carry.

For example, radio communication between the terminal device 10 and the monitor 20 adopts the DSSS (Direct Sequence Spectrum Spread) modulation method and uses a frequency in the 2.4 GHz band. Thus, various functions of the terminal device 10 can be used through the monitor 20 within an approx. 30-meter radius from the terminal device 10.

The recorder 30 incorporates a tuner for receiving ground waves, a BS (Broadcasting Satellite) tuner, and a CS (Communications Satellite) tuner. The individual tuners receive modulated programs carried on radio waves of a specified frequency and demodulate them into programs composed of video signals and audio signals. The recorder 30 has a recording portion which records programs on a built-in recording medium or a mounted recording medium. Available recording media include magnetic tape, magnetic disk, magneto-optic disk, optical disk, and the like.

The recorder 30 has an infrared signal receiving portion 31 which receives various control commands in the form of infrared signal transmitted from the infrared signal transmitter 50 connected with the terminal device 10. The recorder 30 causes various functional parts to operate according to control commands in the form of light energy received at the infrared signal receiving portion 31.

Further, the recorder 30 maybe a recorder-player (not shown) provided with a reproducing portion for replaying programs recorded on the recording medium. If a recorder-player provided with a reproducing portion is used, the recorder-player is connected with the terminal device 10 using an AV (Audio and Video) cable, and reproduced data is outputted to the terminal device 10. The data outputted to the terminal device 10 is transmitted to the radio antenna 21 of the monitor 20 through the transmitting-receiving portion 13 and the radio antenna 14, and is outputted to and displayed on the liquid crystal display portion 22 of the monitor 20.

The server 40 is a server operated by a business operator who provides services associated with the program recording control system 100. Connected with the terminal device 10 through the network, the server 40 delivers EPGs, accepts preselection of programs to be recorded, transmits control commands, the information on preselected programs, and the like to the terminal device 10 connected through the network to control the recorder 30 so that the preselected programs will be properly recorded.

To use the program recording control system 100, the user need make user registration with the server 40 in advance. The server 40 has a data base 41, and, when a user makes user registration, the personal information of the user is stored in the form of table in the database 41.

When the user preselects a program to be recorded, the information on the preselected program is stored as program to be recorded preselection information, together with the personal information, in the database 41 on a user-by-user basis.

The server 40 generates EPGs containing program information, including the airdates (including days of the week), broadcasting start times, broadcasting hours, broadcast channels, and the like of programs, and transmits the EPSs to the terminal devices 10 through the network. The EPGs are generated using program information provided by, for example, television stations which are supposed to broadcast the programs.

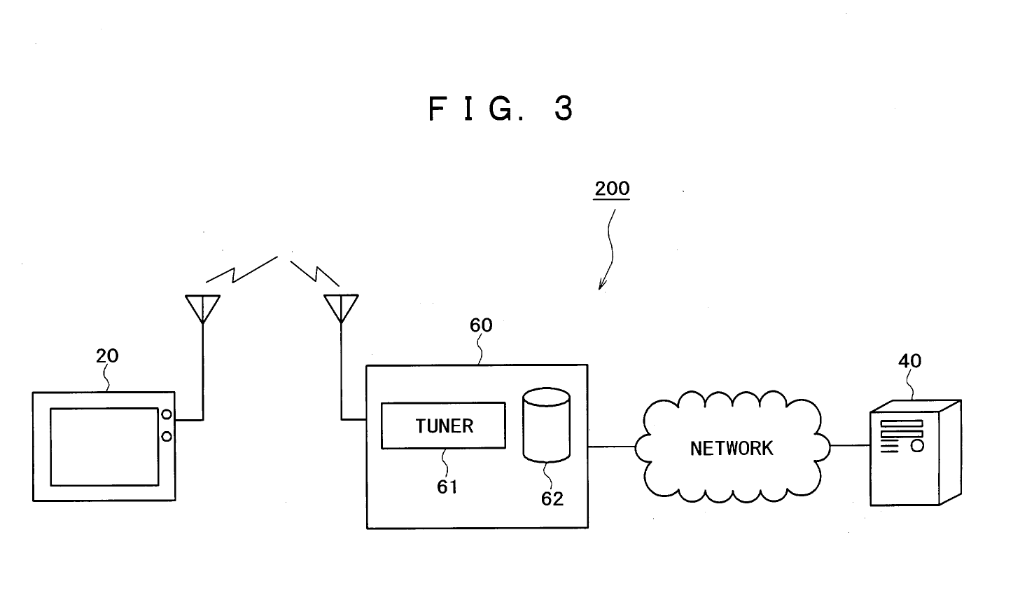

Then, referring to FIG. 3, the program recording control system 200 illustrated as the second embodiment of the present invention will be described.

The program recording control system 200 involves a terminal device 60 provided with the functions of the terminal device 10 and the functions of the recorder 30, instead of the terminal device 10 comprising the program recording control system 100 illustrated as the first embodiment.

That is, the terminal device 60 is provided with a tuner 61 and a recording portion 62 in addition to the functions which the terminal device 10 has.

The tuner 61 is provided with the same functions as the tuner the recorder 30 has, and incorporates a tuner for receiving ground waves, a BS (Broadcasting Satellite) tuner, and a CS (Communications Satellite) tuner. The individual tuners receive modulated programs carried on radio waves of a specified frequency and demodulates them into programs composed of video signals and audio signals.

The recording portion 62 is HDD (Hard Disk Drive) or the like having HD (Hard Disk) or the like and records programs received by the tuner 61.

The other devices comprising the program recording control system 200 are equivalent to those used in the program recording control system 100, and thus the description of the devices is omitted.

Then, the operation of the program recording control system to which the present invention is applied will be described.

In the following description of the operation of the program recording control system, the program recording control system 100 is used for convenience. Naturally, in case the program recording control system 200 is used, the same operation is carried out.

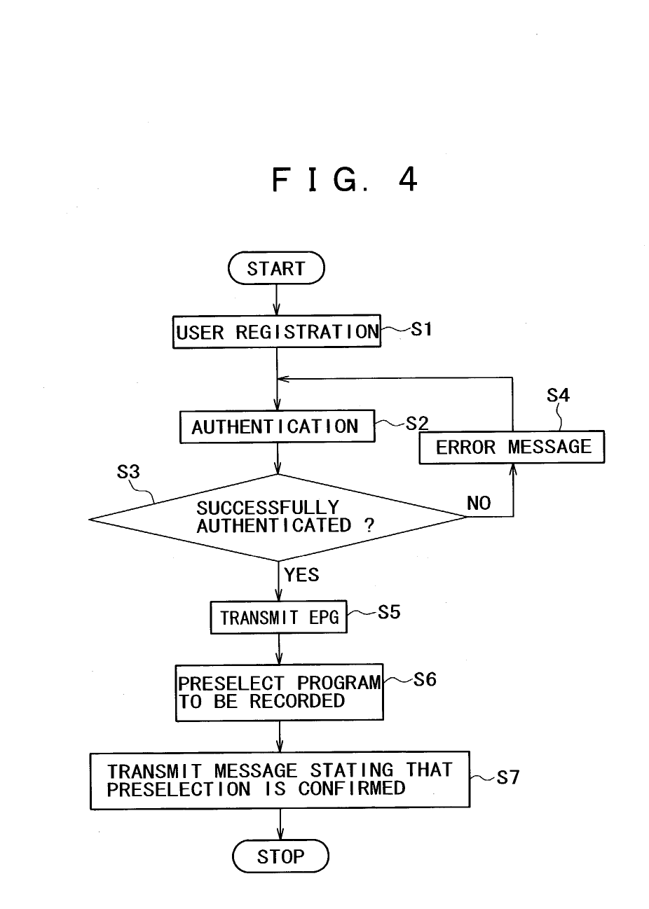

First, referring to the flowchart in FIG. 4, the operation performed when a program to be recorded is preselected with the server 40 will be described.

At Step S1, the user makes user registration with the server 40 for enjoying services associated with the program recording control system.

The user can complete user registration by, for example, accessing a Web page for user registration provided by the server 40 from the terminal device 10 through the network and entering specified user information. Possible information a user should enter during registration include the name, age, occupation, address, and phone number of the user and information on the credit card used for the purpose of billing for use of the service.

After user registration is completed, the user is provided with an ID (IDentification) code and a password which the server 40 can recognize. The user is asked for these pieces of information each time the user preselects a program to be recorded.

The server 40 stores user information in the database 41 on an ID code-by-ID code basis, and further stores the program information of a preselected program to be recorded in the database 41 when the program to be recorded is preselected.

After user registration is completed at Step S1, the user can preselect programs to be recorded. Step S2 and the following steps are steps in which the user preselects a program to be recorded.

At Step S2, the user undergoes authentication at the terminal device 10. To under go authentication before preselecting a program to be recorded, the user connects to the server 40 on the network from the terminal device 10 through the monitor 20.

Authentication by the server 40 is implemented, for example, when the user enters the ID code, password, and the like provided during user registration and the entered ID code, password, and other like information are validated.

If at Step S3, as the result of the authentication, the server 40 judges that the user is not identical with the registered user, the server 40 carries the operation forward to Step S4. If the server 40 judges that the user is identical with the registered user, the server 40 carries the operation forward to Step S5.

At Step S4, the server 40 transmits a message stating that the user failed to be authenticated to the terminal device 10 through the network. If authentication fails, the operation goes back to Step S2, and the user will undergo authentication again.

If authentication is successfully completed, at Step S5, the server 40 accordingly transmits EPG to the terminal device 10 through the network.

The EPG transmitted by the server 40 is generated at the server 40 based on information from television stations supposed to broadcast the program and is updated in real time.

If any change is made to a program to be broadcasted for some reason, such as a reason on the side of the broadcasting station supposed to broadcast the program, a disaster, and social situation, the server 40 generates a new EPG and updates the old one.

The EPG transmitted to the terminal device 10 is in turn transmitted to the monitor 20 by radio, and is displayed as GUI on the liquid crystal display portion 22 of the monitor 20. The EPG displayed as GUI is, for example, a bill of fare which introduces programs in the order of broadcasting opening time on a broadcasting station-by-broadcasting station basis. For programs in the bill of fare, program information, including the titles, brief description of contents, and list of performers of the programs is concisely presented.

At Step S6, the user preselects a program the user desire to record, referring to EPG transmitted from the server 40 and displayed as GUI on the liquid crystal display portion of the monitor 20.

The user can preselect a desired program, for example, by referring to EPG displayed on the liquid crystal display portion 22, which is a touch panel, of the monitor 20 and touching the button labeled “Preselect” affixed to the information on the program.

The program preselection information specified at the monitor 20 is transmitted to the terminal device 10 by radio, and is further transmitted to the server 40 connected through the network. When the server 40 receives the program preselection information, the server 40 stores the received program preselection information in the database 41 and manages the information according to the user ID.

At Step S7, when a program to be recorded is preselected at the terminal device 10 and then the server 40 receives the program preselection information from the terminal device 10, the server 40 transmits a message to the terminal device 10 through the network, which message states that the preselection of the program to be recorded is confirmed.

Thus, the user can make user registration with the server 40 from the terminal device 10 through the monitor 20, and can preselect a desired program to be recorded similarly from the terminal device 10 through the monitor 20 based on EPGs delivered from the server 40.

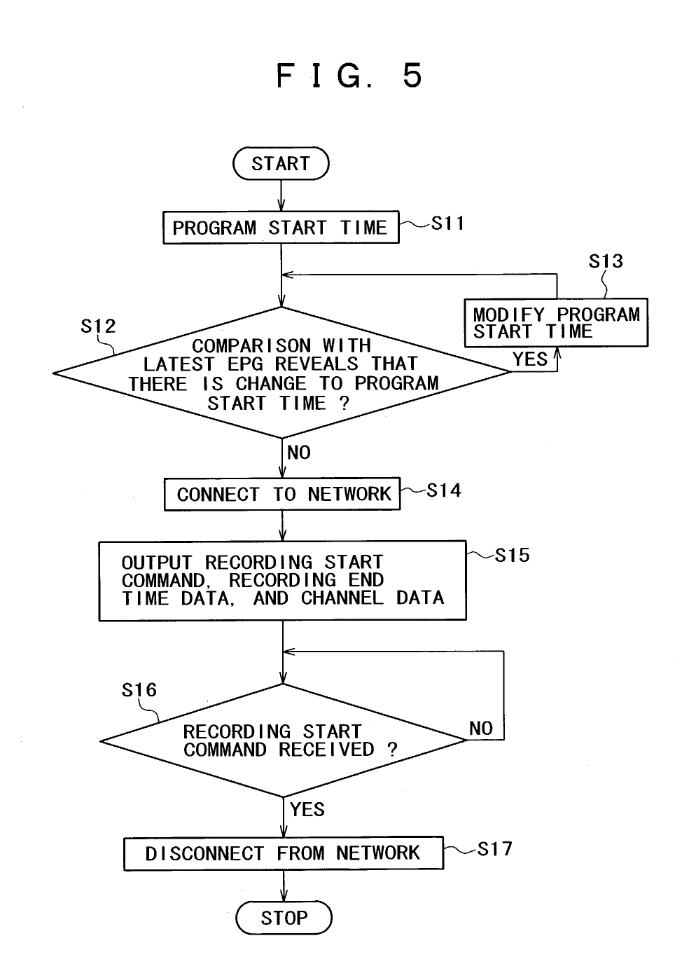

Then, referring to the flowchart in FIG. 5, the operation of the server 40 performed when a program to be recorded preselected with the server 40 is recorded on the recording medium will be described.

As Step S11, the control portion (not shown) of the server 40 keeps comparing the current time with the program start time information for all the registered users of the program preselection information stored in the database 41.

When the current time arrives at the program start time of a preselected program to be recorded or the current time approaches a specified time (for example, one minute before the program start time), the control portion (not shown) extracts the program preselection information and the user information associated with the program whose program start time is matched with the current time or is closing in.

At Step S12, the control portion (not shown) of the server 40 refers to the latest EPG and compares the program start time of the program whose program preselection information was extracted at Step S11 in the latest EPG with the program start time in the program preselection information extracted at Step S11. If there is any change to the program start time, the control portion carries the operation forward to Step S13, and, if there is no change to the program start time, carries the operation forward to Step S14.

At Step S13, the control portion (not shown) of the server 40 modifies the program start time information in the program preselection information stored in the database 41 based on the latest EPG, and stores the modified information in the database 41 again.

If there is no change to the program start time, at Step S14, the control portion (not shown) of the server 40 accordingly finds the phone number of the terminal device 10 of the user in the extracted user information and establishes dialup connection at the phone number through the network.

At Step S15, the control portion (not shown) of the server 40 generates a power ON command, a received channel control command based on received channel information, which is information indicating the channel on which the program is broadcasted, and a recording command for starting the operation of the recording portion of the recorder and transmits the commands as a recording start command, together with the recording end time information of the program extracted from the program preselection information, to the terminal device 10 through the network.

At Step S16, the control portion (not shown) of the server 40 is brought into wait state, in which the control portion waits for an acknowledging message transmitted from the terminal device 10 through the network, to confirm whether the recording start command transmitted at Step S15 has reached the terminal device 10.

The control portion (not shown) of the server 40 carries the operation forward to Step S17 if the acknowledging message is received, and is kept in wait state if the acknowledging message fails to be received.

If the acknowledging message is received, at Step S17, the control portion (not shown) of the server 40 accordingly disconnects from the network through which the server 40 is connected with the terminal device 10 and terminates the operation.

Thus, when the broadcasting opening time of the preselected program to be recorded closes in, the server 40 outputs a recording start command to the terminal device 10 through the network based on the accepted program preselection information to cause recording of the program to be started.

Further, any disagreement in recording start time which can be produced due to switching of programs, delay in broadcasting start time, or the like can be eliminated by comparing the program start time at the time of preselection with the program start time in the latest EPG, and updating the old program start time.

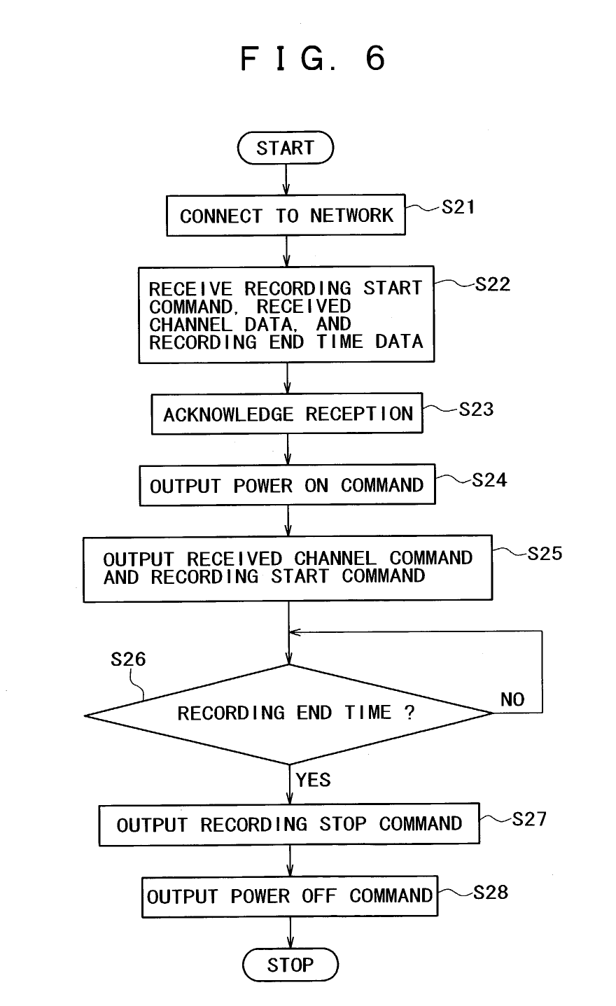

Then, referring to the flowchart in FIG. 6, the operation of the terminal device 10 performed when a program to be recorded preselected with the server 40 is recorded on the recording medium will be described.

At Step S21, the terminal device 10 is connected with the server 40 through the network by dialup from the server 40 to the terminal device 10.

At Step S22, the terminal device 10 receives a recording start command and recording end time information transmitted from the server 40. The received recording start command and recording end time information are sent out to the recorder control portion 12 under control of the CPU 47. The recording end time information is stored in the memory (not shown) of the recorder control portion 12.

At Step S23, the CPU 47 of the terminal device 10 returns to the server 40 an acknowledging message stating that the recording start command transmitted from the server 40 through the network has been received. As mentioned above, when the server 40 receives the acknowledging message, the server 40 accordingly disconnects from the network.

If the recording start command is received at Step S22, at Step S24, the CPU 47 of the terminal device 10 accordingly controls the recorder control portion 12 to extract the power ON command for turning on the power to the recorder 30, from the recoding start command. The extracted power ON command is outputted to the infrared signal transmitter 50.

The infrared signal transmitter 50 converts the power ON command into an infrared signal and transmits the signal to the recorder 30. When the power ON command in the form of infrared signal is received by the recorder 30, the power to the recorder 30 is accordingly turned on.

At Step S25, the CPU 47 of the terminal device outputs the received channel control command and the recording command in the recording start command received at Step S22 to the infrared signal transmitter 50.

The infrared signal transmitter 50 converts the received channel control command and the recording start command into infrared signals and transmits the signals to the recorder 30. When the received channel control command and recording start command in the form of infrared signal are received by the recorder 30, recording of the program broadcasted on the desired channel on the recording medium is thereby started.

At Step S26, the recorder control portion 12 monitors the recording end time information stored in the memory (not shown) and judges whether the recording end time arrives. The recorder control portion 12 carries the operation forward to Step S27 when the recording end time has arrived and is brought into standby state if the recording end time has not arrived yet.

At Step S27, the recorder control portion 12 of the terminal device 10 generates a recording stop command. The generated recording stop command is outputted to the infrared signal transmitter 50.

The infrared signal transmitter 50 converts the recording stop command into an infrared signal and transmits the signal to the recorder 30. When the recording stop command in the form of infrared signal is received by the recorder 30, the operation of recording the desired program on the recording medium is thereby stopped.

At Step S28, the recorder control portion 12 of the terminal device 10 generates a power OFF command. The generated power OFF command is outputted to the infrared signal transmitter 50.

The infrared signal transmitter 50 converts the power OFF command into an infrared signal and transmits the signal to the recorder 30. When the power OFF command in the form of infrared signal is received by the recorder 30, the power to the recorder 30 is accordingly turned off with only required standby power left on.

Thus, the terminal device 10 controls the recorder 30 according to the recording start command generated at and transmitted from the server 40 and controls recording of a desired program preselected with the server 40 by the user on the recording medium.

The foregoing invention has been described in terms of preferred embodiments. However, those skilled, in the art will recognize that many variations of such embodiments exist. Such variations are intended to be within the scope of the present invention and the appended claims.

What is claimed is:

1. A server connected through a network with a terminal device which controls the program recording operation of a program recorder for recording a program received by a receiving means on a recording medium, the server comprising:
a bill-of-fare generating means for generating a bill of fare containing program start time information indicating the program start time of programs to be broadcasted each time the program start time is updated;
a bill-of-fare transmitting means for transmitting the bill of fare generated by the bill-of-fare generating means to the terminal device through the network;
a program-recording-request receiving means for receiving a program recording request to record the specified program on the recording medium, the request being transmitted from the terminal device through the network based on the bill of fare transmitted to the terminal device by the bill-of-fare transmitting means;
a comparing means for, when the program start time of the program for which the program recording request was made by the terminal device arrives, comparing the program start time of the program for which the program recording request was made with the program start time of the program in the latest bill of fare updated by the bill-of-fare generating means;
a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means; and
a program-recording-start command transmitting means for transmitting the program recording start command generated by the program-recording-start command generating means to the terminal device through the network.

2. The server according to claim 1,
wherein
the bill of fare contains program end time information indicating the time when the program for which the recording request was made is ended;
and wherein
the server comprises a program-end-time information transmitting means which transmits the program end time information to the terminal device.

3. A terminal device which is connected with a server through a network and controls the program recording operation of a program recorder for recoding a program received by a receiving means on a recording medium, the terminal device comprising:
a bill-of-fare receiving means for receiving a bill of fare which is transmitted from the server through the network and contains program start time information indicating the program start times of programs to be broadcasted;
a program-recording-request transmitting means for transmitting a program recording request to record a specified program on the recording medium to the server through the network based on the bill of fare received by the bill-of-fare receiving means; and
a program-recording-start command receiving means for receiving a program recording start command to start recording of the specified program on the recording medium, transmitted from the server.

4. The terminal device according to claim 3,
wherein
the bill of fare contains program end time information indicating the time when the broadcasting of the program for which the recording request was made is ended;
and wherein
the terminal device comprises:
a program-end-time information receiving means for receiving the program end time information transmitted from the server through the network, and
a program-recording-stop command generating means for, when the end time of the program arrives, generating a program recording end command for ending the operation of recording the program on the recording medium based on the program end time information received by the program-end-time information receiving means.

5. A terminal device which is connected with the server through the network, comprising:
a bill-of-fare receiving means for receiving bills of fare which is transmitted from the server through the network and contains program start time information indicating the program start times of programs to be broadcasted;
a program-recording-request transmitting means for transmitting a program recording request to record a specified program on the recording medium to the server through the network based on the bill of fare received by the bill-of-fare receiving means;
a program-recording-start command receiving means for receiving a program recording start command instructing to start recording of the program on the recording medium, transmitted from the server;
a program receiving means for receiving the program listed in the bill of fare;
a recording means for recording the program received by the program receiving means on the recording medium; and
a controlling means for controlling the program receiving means and the recording means so that the program for which the program recording request was made is recorded on the recording medium according to the program recording start command received by the program-recording-start command receiving means.

6. The terminal device according to claim 5,
wherein
the bill of fare contains program end time information indicating the time when the program for which the recording request was made is ended;
wherein
the terminal device comprises:
a program-end-time information receiving means for receiving the program end time information transmitted from the server through the network, and
a program-recording-stop command generating means for, when the end time of the program arrives, generating a program recording stop command for stopping the operation of recording the program on the recording medium based on the program end time information received by the program-end-time information receiving means; and
wherein
the controlling means controls the recording means so that the operation of recording the program for which the program recording request was made is stopped according to the program recording stop command generated by the program-recording-stop command generating means.

7. A program recording control system
wherein
a terminal device which controls the program recording operation of a program recorder for recording programs received by a receiving means on a recording medium and a server are connected with each other through a network;
wherein
the server comprises:
a bill-of-fare generating means for generating a bill of fare containing program start time information indicating the program start times of programs to be broadcasted each time the program start time is updated,
a bill-of-fare transmitting means for transmitting the bills of fare generated by the bill-of-fare generating means to the terminal device through the network,
a program-recording-request receiving means for receiving a program recording request to record a specified program on the recording medium, transmitted from the terminal device through the network based on the bill of fare transmitted to the terminal device by the bill-of-fare transmitting means,
a comparing means for, when the program start time of the program for which the program recording request was made by the terminal device arrives, comparing the program start time of the program for which the program recording request was made with the program start time of the program in the latest bill of fare updated by the bill-of-fare generating means,
a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means, and
a program-recording-start command transmitting means for transmitting the program recording start command generated by the program-recording-start command generating means to the terminal device through the network;
and wherein
the terminal device comprises:
a bill-of-fare receiving means for receiving bills of fare transmitted from the bill-of-fare transmitting means of the server through the network,
a program-recording-request transmitting means for transmitting a program recording request to record a specified program on the recording medium to the server through the network based on the bill of fare received by the bill-of-fare receiving means, and
a program-recording-start command receiving means for receiving the program recording start command transmitted from the program-recording-start command transmitting means of the server.

8. The program recording control system according to claim 7,
wherein
the bill of fare contains program end time information indicating the time when the program for which the recording request was made is ended;
wherein
the server comprises:
a program-end-time information transmitting means for transmitting the program end time information to the terminal device through the network;
and wherein
the terminal device comprises:
a program-end-time information receiving means for receiving the program end time information transmitted from the server through the network, and
a program-recording-end command generating means for, when the end time of the program arrives, generating a program recording end command for stopping the operation of recording the program on the recording medium based on the program end time information received by the program-end-time information receiving means.

9. A program recording control method for a program recording control system
wherein
a terminal device which controls the program recording operation of a program recorder for recording programs received by a receiving means on a recording medium and a server are connected with each other through a network;
wherein
the server generates a bill of fare containing program start time information indicating the program start times of programs to be broadcasted each time the program start time is updated, and transmits the generated bill of fare to the terminal device through the network;
wherein
the terminal device receives the bill of fare transmitted from the server through the network, and transmits a program recording request to record a specified program on the recording medium to the server through the network based on the received bill of fare;
wherein
the server receives the program recording request transmitted from the terminal device through the network,
when the program start time of the program for which the program recording request was made by the terminal device arrives, compares the program start time of the program for which the program recording request was made with the program start time of the program in the updated and latest bill of fare,
generates a program recording start command for starting recording of the specified program on the recording medium, according to the result of the comparison that the program start time of the program for which the program recording request was made is matched with the program start time of the program in the updated and latest bill of fare, and
transmits the generated program recording start command to the terminal device through the network;
and wherein
the terminal device receives the program recording start command transmitted from the server through the network.

10. The program recording control method according to claim 9,
wherein
the server transmits program end time information indicating the time when the broadcasting of the program which is contained in the bill of fare and for which the recording request was made is ended, together with the program recording start command, to the terminal device through the network;
and wherein
the terminal device receives the program end time information transmitted from the server through the network, and
when the end time of the program arrives, generates a program recording stop command for stopping the operation of recording the program on the recording medium based on the received program end time information.

11. A program recording control system wherein a server and a terminal device are connected with each other through a network,
wherein
the server comprises:
a bill-of-fare generating means for generating a bill of fare containing program start time information indicating the program start times of programs to be broadcasted each time the program start time is updated,
a bill-of-fare transmitting means for transmitting bills of fare generated by the bill-of-fare generating means to the terminal device through the network,
a program-recording-request receiving means for receiving a program recording request to record a specified program on a recording medium, transmitted from the terminal device through the network based on the bill of fare transmitted to the terminal device by the bill-of-fare transmitting means,
a comparing means for, when the program start time of the program for which the program recording request was made by the terminal device arrives, comparing the program start time of the program for which the program recording request was made with the program start time of the program in the lasted bill of fare updated by the bill-of-fare generating means,
a program-recording-start command generating means for generating a program recording start command for starting recording of the specified program on the recording medium, according to the result of the comparison by the comparing means that the program start time of the program for which the program recording request was made is matched with the program start time of the program in the latest bill of fare updated by the bill-of-fare generating means, and
a program-recording-start command transmitting means for transmitting the program recording start command generated by the program-recording-start command generating means to the terminal device through the network;
and wherein
the terminal device comprises:
a bill-of-fare receiving means for receiving bills of fare transmitted from the bill-of-fare transmitting means of the server through the network,
a program-recording-request transmitting means for transmitting a program recording request to record a specified program on the recording medium to the server through the network based on the bill of fare received by the bill-of-fare receiving means,
a program-recording-start command receiving means for receiving the program recording start command transmitted from the program-recording-start command transmitting means of the server,
a program receiving means for receiving programs listed in the bill of fare,
a recording means for recording the programs received by the program receiving means on the recording medium, and
a controlling means for controlling the program receiving means and the recording means so that the program for which the program recording request was made is recorded on the recording medium according to the program recording start command received by the program-recording-start command receiving means.

12. The program recording control system according to claim 11,
wherein
the bill of fare contains program end time information indicating the time when the broadcasting of the program for which the recording request was made is ended;
wherein
the server comprises a program-end-time information transmitting means for transmitting the program end time information to the terminal device through the network;
wherein
the terminal device comprises:
a program-end-time information receiving means for receiving the program end time information transmitted from the program-end-time information transmitting means of the server through the network, and
a program-recording-stop command generating means for, when the end time of the program arrives, generating a program recording stop command for stopping the operation of recording the program on the recording medium based on the program end time information received by the program-end-time information receiving means;
and wherein
the controlling means controls the recording means so that the operation of recording the program for which the program recording request was made is stopped according to the program recording stop command generated by the program-recording-stop command generating means.

13. A program recording control method for a program recording control system
wherein
a server and a terminal device are connected with each other through a network;
wherein
the server generates a bill of fare containing program start time information indicating the program start times of programs to be broadcasted each time the program start time is updated, and
transmits the generated bill of fare to the terminal device through the network;
wherein
the terminal device receives the bill of fare transmitted from the server through the network, and
transmits a program recording request to record a specified program on a recording medium to the server through the network based on the received bill of fare;
wherein
the server receives the program recording request transmitted from the terminal device through the network,
when the program start time of the program for which the program recording request was made by the terminal device arrives, compares the program start time of the program for which the program recording request was made with the program start time of the program in the latest bill of fare updated by the bill-of-fare generating means,
generates a program recording start command for starting recording of the specified program on the recording medium, according to the result of the comparison that the program start time of the program for which the program recording request was made is matched with the program start time of the program in the latest bill of fare updated by the bill-of-fare generating means, and
transmits the generated program recording start command to the terminal device through the network;
and wherein
the terminal device receives the program recording start command transmitted from the server, and
controls a program receiving means for receiving programs listed in the bill of fare and a recording means for recording the programs received by the program receiving means so that the program for which the program recording request was made is recorded on the recording medium according to the received program recording start command.

14. The program recording control method according to claim 13,
wherein
the server transmits program end time information indicating the time when the broadcasting of the program which is contained in the bill of fare and for which the recording request was made is ended to the terminal device through the network;
and wherein
the terminal device receives the program end time information transmitted from the server through the network, together with the program recording start command,
when the end time of the program arrives, generates a program recording stop command for stopping the operation of recording the program on the recording medium based on the received program end time information, and
controls the recording means so that the operation of recording the program for which the program recording request was made is stopped according to the generated program recording stop command.
